(19) United States
(12) Patent Application Publication
(10) Pub. No.: US 2026/0024072 A1
(43) Pub. Date: Jan. 22, 2026

(54) SECURE CONVERSATIONAL PAYMENT SERVICE

(71) Applicant: American Express Travel Related Services Company, Inc., New York, NY (US)

(72) Inventors: Jill Marie Bartholomew, Downingtown, PA (US); Siva Kumar Edupuganti, Phoenix, AZ (US); Jaswandi Vijay Sakpal, South Jordan, UT (US); Aditya Yallaturu, Coral Springs, FL (US)

(21) Appl. No.: 18/776,932

(22) Filed: Jul. 18, 2024

(51) Int. Cl. G06Q 20/32; G06Q 20/40

(52) U.S. Cl. CPC G06Q 20/3255; G06Q 20/4037

(57) ABSTRACT

Disclosed are various embodiments for a chat service that enables user to make payments to bill providers without having to share sensitive information during a chat session. In one example, a system is configured to identify a payment request derived from a text message. A first entity identifier and a second entity identifier can be determined. A first computing device can be queried for a first list of accounts based on the first entity identifier. A second computing device can be queried for a second list of accounts based on the second entity identifier. A billing account and a funding account that matches a set of identity matching criteria can be identified from the first list of accounts and the second list of accounts. The payment request can be executed based at least in part on the billing account and the funding account.

### BACKGROUND

Online bill paying services emerged as a convenient feature for consumers to pay their bills after the emergence of the Internet. Typically, a bill pay service involves a consumer entering a billing account of a billing service provider, a payment amount, a payment date, and other relevant information. Online bill paying services provided a cheaper, faster and more convenient option compared to writing checks for paying bills.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a chat user interface rendered by a mobile device according to various embodiments of the present disclosure.

FIG. 2 is a drawing of a network environment according to various embodiments of the present disclosure.

FIGS. 3A-3F are drawings of user interfaces rendered by the client device in the network environment of FIG. 2 according to various embodiments of the present disclosure.

FIG. 4 is a sequence diagram illustrating one example of functionality implemented executed in the network environment of FIG. 2 according to various embodiments of the present disclosure.

FIG. 5 is a flowchart illustrating one example of functionality implemented as portions of a client application executed in the client device in the network environment of FIG. 2 according to various embodiments of the present disclosure.

FIG. 6 is a flowchart illustrating one example of functionality implemented as portions of a payment service executed in a computing environment in the network environment of FIG. 2 according to various embodiments of the present disclosure.

### DETAILED DESCRIPTION

The various embodiments of the present disclosure relate to a chat service that enables consumers to make payments to bill providers without having to share sensitive information, such as credit card numbers, bank account numbers, personal identifying information, billing account information, and other sensitive information, in a chat session. As a non-limiting example, the embodiments can be implemented as a conversational chat service that receives a payment command and identifies the appropriate accounts for executing the payment command, without having the consumer enter the full account numbers for the billing provider and/or the financial institution.

Traditionally, an online bill pay service involves a consumer entering a billing account of a billing service provider, a payment amount, a payment date, a bank account information, and other relevant information. However, there are several limitations and technical problems that have emerged with online bill paying services. For example, in many situations, a consumer has to enter sensitive payment information (e.g., a bank routing number, a banking account number, credit card number, etc.) and a billing service provider account. As such, the consumer has to rely on the billing provider system to keep the consumer's sensitive payment information secure from unauthorized users and protect against potential data breaches. Further, the consumer may submit payment information to multiple online systems of several billing providers, which increases the user's exposure against unauthorized users and data breaches. Additionally, in situations where the user's payment information (e.g., a new credit card number) needs to be updated, the user has to go to each billing provider and update the payment information, which can be a time-consuming process. Lastly, some online messaging platforms can have security issues because unauthorized users may be able to intercept messages by accessing a network associated with the user, particularly messaging platforms that do not implement an end-end encryption scheme. As such, if payment information and other sensitive data is included in a text message or a chat session, the information can be accessed by unauthorized users.

Accordingly, the various embodiments of the present disclosure provide various advantages over the current online billing services and online messaging platforms. For instance, the embodiments provide a single chat user interface that can be used to instruct payments for various billing providers. As a result, the user does not have to multiple billing websites and billing mobile applications. The embodiments provide a user interface that is able to interface with various billing provider systems.

As previously mentioned, the user does not have to enter sensitive payment information or billing account information in their entirety in the various embodiments of the present disclosure. Further, various embodiments enable user to make sure in a chat service interface, which is previously an unsecure environment. As such, the consumer can make payments in a more secure manner than previous billing payment services. As a result, the embodiments enable for payments to bill providers to be made in a quicker and more secure manner.

Additionally, the various embodiments enable the mobile devices of users to interface with additional funding source systems for making payments to bill service providers. For example, the embodiments allow for the integration of peer-to-peer payment services (e.g., Venmo®, Square®, PayPal®, etc.). As a result, users can access a peer-to-peer payment account to make payments to billing providers. In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

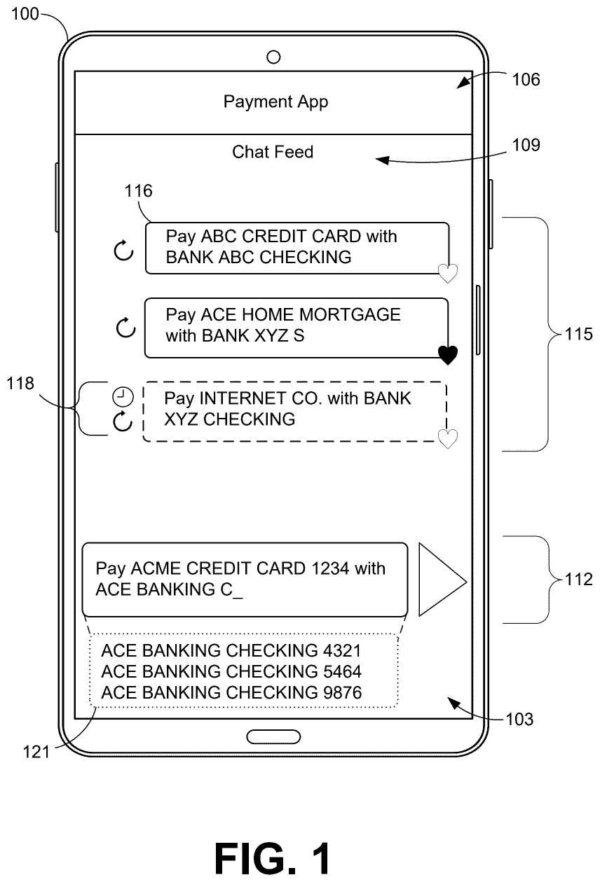

With reference to FIG. 1, shown is a mobile device 100 that is displaying a chat user interface 103 for a payment application 106. The payment application 106 can be associated with a financial service provider, such as a bank, a credit card provider, a credit union, and other suitable financial entities. The chat user interface 103 includes a chat feed 109, an input component 112, and other suitable interface components.

The chat feed 109 includes a record 115 of completed payment requests and pending payment requests. A completed payment request can represent a successfully completed payment, in which funds from a funding account of the user were applied to a billing account of the user at a billing service provider. A pending payment request can represent a request that has been submitted, but has not yet been completed.

Each payment request 116 can include a billing provider identifier (e.g., an identifier for a credit card provider, a utilities provider, a mortgage provider, a debit service provider, etc.) and a funding provider identifier (e.g., a banking institution, a credit union, a peer-to-peer monetary transfer platform, etc.). For example, in FIG. 1, the billing provider identifier is “ABC CREDIT CARD” and the funding provider identifier is “BANK ABC CHECKING.” As such, a payment request can be entered according to a syntax for the payment application 106 to identify the appropriate parameters. In this example, the payment request 116 is a command for the payment application 106 to execute a payment to a credit card account of the user at ABC CREDIT CARD using funds from a checking bank account at BANK ABC. As previously noted, the payment request does not include sensitive information, such as a full billing account number, a full banking account number, a full routing number, a full credit card number, or other sensitive information. The payment application 106 can identify the necessary payment information based on the limited information provided in the payment request and a user identifier associated with the user.

In some examples, the payment request 116 can include one or more payment parameters 118. The payment parameters 118 can represent one or more conditions associated with the payment request 116. Some non-limiting examples of the payment parameters 118 can include a scheduled time for the payment request, an instruction for repeating the payment request, an instruction for storing the payment request as a favorite, a payment amount, and other suitable payment parameters.

The input component 112 can be configured to receive an input of a series of characters to represent a command or an instruction by the user. The input component 112 can activate an autocomplete window 121 as the user is entering characters into the input component 112. The autocomplete can display suggested funding provider identifiers and/or funding provider identifiers based at least in part on data stored in the mobile device 100 and associated with the payment application 106.

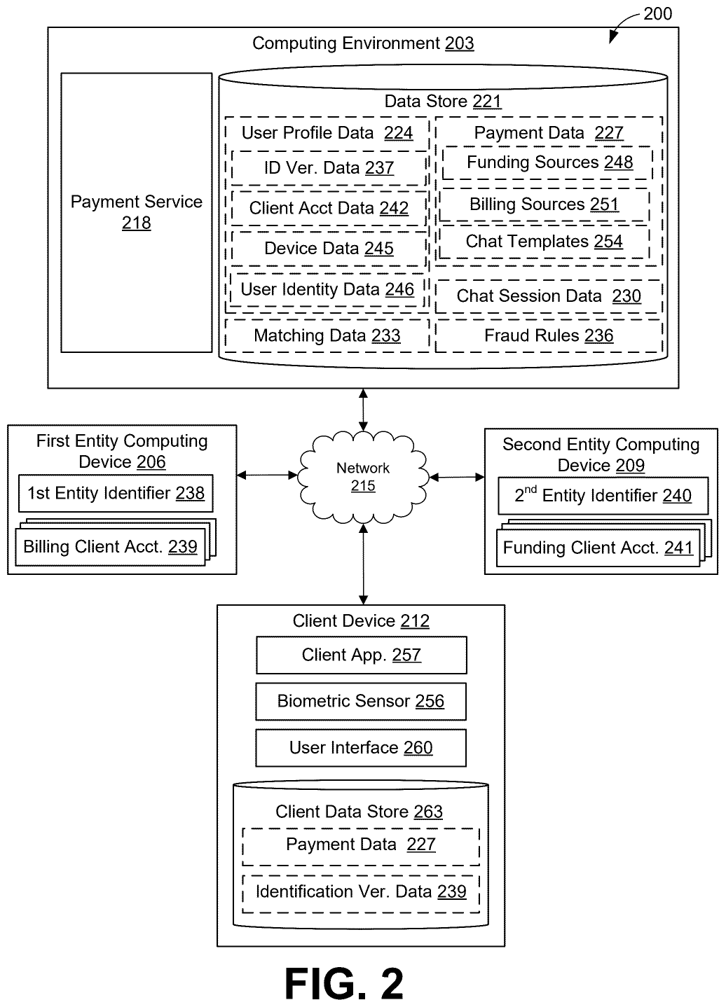

With reference to FIG. 2, shown is a networked environment 200 according to various embodiments. The networked environment 200 can include a computing environment 203, a first entity computing device 206, a second entity computing device 209, and a client device 212, which can be in data communication with each other via a network 215.

The network 215 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 215 can also include a combination of two or more networks 215. Examples of networks 215 can include the Internet, intranets, extranets, virtual private networks (VPNs), and similar networks.

The computing environment 203 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a payment service 218, and other applications, services, processes, systems, engines, or functionality not discussed in detail herein.

The payment service 218 can be executed to facilitate the execution of a payment request received from the client device 212 during a chat session. The payment request can be received from the client device 212 and can be interpreted in order to execute the payment request. The payment service 218 can involve interpreting the payment request by identifying entity identifiers, payment parameters, and other suitable payment data from the payment request. The payment service 218 can retrieve additional information (e.g., funding client account numbers, billing client numbers, etc.) needed in order to execute the payment information.

Also, various data is stored in a data store 221 that is accessible to the computing environment 203. The data store 221 can be representative of a plurality of data stores 221, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 221 is associated with the operation of the various applications or functional entities described below. This data can include user profile data 224, payment data 227, chat session data 230, matching data 233, fraud rules 236, and potentially other data.

The user profile data 224 can represent data stored for individual user profiles associated with users. The user profile data 224 can include identity verification data 237, client account data 242, device data 245, user identity data 246, and other suitable data. The identify verification data 237 can represent data associated with authenticating a user. The identification verification data 339 can include biometric authentication data, such as facial scans, fingerprint scans, vocal utterances, and other suitable biometric authentication data.

The client account data 242 can represent accounts associated with the user that have been retrieved from the first entity computing device 206, the second entity computing device 209, and from other suitable data sources. For example, the client accounts can include billing client accounts, funding client accounts, and other types of user accounts. The device data 245 can represent data associated with the client device 212 of the user. For example, the device data 245 can include a phone number, an Internet protocol (IP) address, an International Mobile Equipment Identity (IMEI), and other suitable identifiers for a client device 212.

The user identity data 246 can represent data associated with a user identity or a user identifier for a user. The user identity data 246 can be used to identify a particular user. Some non-limiting examples of user identity data 246 can include a name, an email address, a phone number, a mailing address, a social security number, a birthdate, a driver's license number, a passport number, and other suitable user identifying data.

The payment data 227 can represent data provided to the client device 212 for facilitating the execution of functionality associated with the payment service 218. The payment data 227 can include funding sources 248, billing sources 251, chat templates 254, and other suitable data. The funding sources 248 can represent data associated with financial institutions, such as client accounts and other suitable data. The billing sources 251 can represent data associated with billing service providers associated with a user, such as credit card companies, utilities service providers, debit service providers, and other suitable data. The funding sources 248 and the billing sources 251 can be used by an autocomplete feature while entering a payment request.

The chat templates 254 can represent data associated with one or more templates for a conversational chat interaction with the user. Each template can represent a dialogue structure that includes possible statements and/or questions presented to the user, possible user responses expected to be received, a set rules for determining a sequence of statements, questions, user responses, and other elements for a conversational chat interaction with the user. For example, a chat template 254 can be associated with a “Pay” command during a chat session. The chat template for the “Pay” command can instruct the client device 212 to extract certain identifiers and parameters from the payment request. The chat template can include syntax, such as a structure in a payment request for identifying the various parameters. For example, a payment request can be structured to identify in order the “Pay” command first, then a first entity identifier, and the second entity identifier last. Other examples can include a chat template with a different sequence for identifying the identifiers and parameters.

The chat session data 230 can represent data associated with a record or a history of conversational chat interactions with individual users. The chat session data 230 can include a record of completed payment requests, pending payment requests, time stamp data, and other suitable data.

The matching data 233 can represent data associated with one or more matching criteria or rules for matching billing sources 251 and funding sources 248 to a particular user. For example, an identity matching criteria can include a three-way match that includes matching a same set of three data elements of user identity data 246 to both a first account of a billing source 251 and a second account of a funding source 248. For instance, the same set of three data elements can include the name, mailing address, and phone number. Each of these three data elements of user identity data 246 have to match both the first account and the second account.

In other examples, a matching rule (e.g., from matching data 233) can be configured for payment requests that exceed a payment amount threshold. In these situations, the matching rule can require matching five data elements of user identity data.

The fraud rules 236 can include one or more rules for identifying fraudulent payment requests. For example, the fraud rules 236 can include rules for identifying client devices 212 using an IP address, a phone number, an email address, and other suitable device data that have been previously associated with a compromised device.

The first entity computing device 206 can represent a system of one or more billing service providers. The first entity computing device 206 can include a first entity identifier 238, a list of billing client accounts 239, and other suitable data. The first entity identifier 238 can represent a unique identifier for the first entity computing device 206, such as a name, a number, an alphanumeric set of characters, and other suitable identifiers. The list of billing client accounts 239 can represent various billing user accounts at a billing service provider.

The second entity computing device 209 can represent a system of one or more financial service providers. The second entity computing device 209 can include a second entity identifier 240, a list of billing client accounts 239, and other suitable data. The second entity identifier 240 can represent a unique identifier for the second entity computing device 209, such as a name, a number, an alphanumeric set of characters, and other suitable identifiers. The list of funding client accounts 241 can represent various funding user accounts at a financial service provider, such as a banking checking account, a banking debit account, a credit card account, a peer-to-peer monetary account, and other suitable accounts.

The client device 212 is representative of a plurality of client devices that can be coupled to the network 215. The client device 212 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, set-top boxes, and similar devices), a videogame console, or other devices with like capability. The client device 212 can include one or more displays, such as liquid crystal displays (LCDs), gas plasma-based flat panel displays, organic light emitting diode (OLED) displays, electrophoretic ink (“E-ink”) displays, projectors, or other types of display devices. In some instances, the display can be a component of the client device 212 or can be connected to the client device 212 through a wired or wireless connection.

The client device 212 comprises a biometric sensor 256 that can be used to generate biometric scans for biometric authentication. Prior to the payment request being submitted or processed, the client device 212 can execute a biometric authentication. The biometric sensor 256 can include an imaging or optical device for generating biometric scans, such as facial scans, fingerprint scans, and other suitable data. The biometric sensor 256 can also include a microphone for capturing an utterance of a user and verifying the authenticity of the user.

The client device 212 can be configured to execute various applications such as a client application 257 or other applications. The client application 257 is executed to operate messaging functionality, in which payment requests can be initiated with an input of a text message (e.g., a chat message). The client application 257 can be in data communication with the payment service 218.

The client application 257 can also be executed in a client device 212 to access network content served up by the computing environment 203 or other servers, thereby rendering a user interface 260 on the display. To this end, the client application 257 can include a browser, a dedicated application, or other executable, and the user interface 260 can include a network page, an application screen, or other user mechanism for obtaining user input. The client device 212 can be configured to execute applications beyond the client application 257 such as email applications, social networking applications, word processors, spreadsheets, or other applications.

Also, various data is stored in a client data store 263 that is accessible to the client device 212. The client data store 263 can include the payment data 227 and the identity verification data 237, and other suitable data.

Next, a general description of the operation of the various components of the networked environment 200 is provided. To begin, a user can desire to make a payment to a billing service provider using a funding account owned by the user. The client application 257 can display a user interface 260, which can include a chat feed and an input component (e.g., FIG. 1 (109, 112)). In some examples, the user can enter a payment request into the input component of the user interface 260. The payment request may need to follow a structure or a syntax in order for the client application 257 to identify the appropriate command, identifiers, parameters, conditions, and/or other suitable data elements.

For example, the entry of “Pay HAPPY VALLEY UTILITY with ACE BANK CHECKING” can be received and can be recognized as a payment request for a user identifier of the user. The “Pay” characters can be identified as a command for initiating a payment request. Since the Pay command has been recognized, a chat template 254 can be used for interpreting the rest of the text entry. As a result, the associated chat template can be used to identify the “HAPPY VALLEY UTILITY” as a first entity identifier 238 and the “ACE BANK” can be identified as a second entity identifier 240. It also should be noted that the “CHECKING” can be identified as an account characteristic.

Next, the client application 257 can perform (via the biometric sensor 256) a biometric authentication to verify the user is authorized to make payment requests on the client device 212. Upon the user being verified, the client application 257 can transmit the payment request to the payment service 218.

The payment service 218 can receive the payment request and can extract the various identifiers, parameters, conditions, and/or other suitable data elements. For example, the payment service 218 can identify the user identity data 246 (e.g., an email address or a phone number) for a user identifier, the “HAPPY VALLEY UTILITY” as the first entity identifier 238, the “ACE BANK” can be identified as the second entity identifier 240, “CHECKING” as an account characteristics, and other suitable parameters.

The payment service 218 can query a first entity computing device 206 for HAPPY VALLEY UTILITY for a list of billing client accounts 239 associated with the user identity data 246 (e.g., an email address, a phone number, a name, etc.). Additionally, the payment service 218 can query a second entity computing device 209 for ACE BANK for a list of funding client accounts 241 associated with the user identity data 246.

After the list of billing client accounts 239 and the list of funding client accounts 241 are received, the payment service 218 can determine a particular billing client account 239 and a particular funding client account 241 that match an identity matching criteria (e.g., matching data 233). For example, the identity matching criteria can include matching a name, an email address, and a mailing address for both the particular billing client account 239 and the particular funding client account 241. If one of the three data elements do not match on both accounts, then the match is not successful, and the payment request can be terminated.

If the three data elements do match, then the payment service 218 can proceed to determine whether the particular client account matches certain account characteristics (e.g., checking). The account characteristics can be determined from the payment request, such as the account type, a partial account identifier, and other suitable data. In other examples, an account characteristic can include the account balance for the client account, which could be determined by checking whether the funding client account has sufficient funds for completing the payment request. Then, the payment service 218 can execute the payment request by issuing a debit to the second entity computing device 209 for the particular funding client account 241 (e.g., checking account) at ACE BANK and by issuing a credit to the first entity computing device 206 for the particular billing client account 239 at HAPPY VALLEY UTILITY.

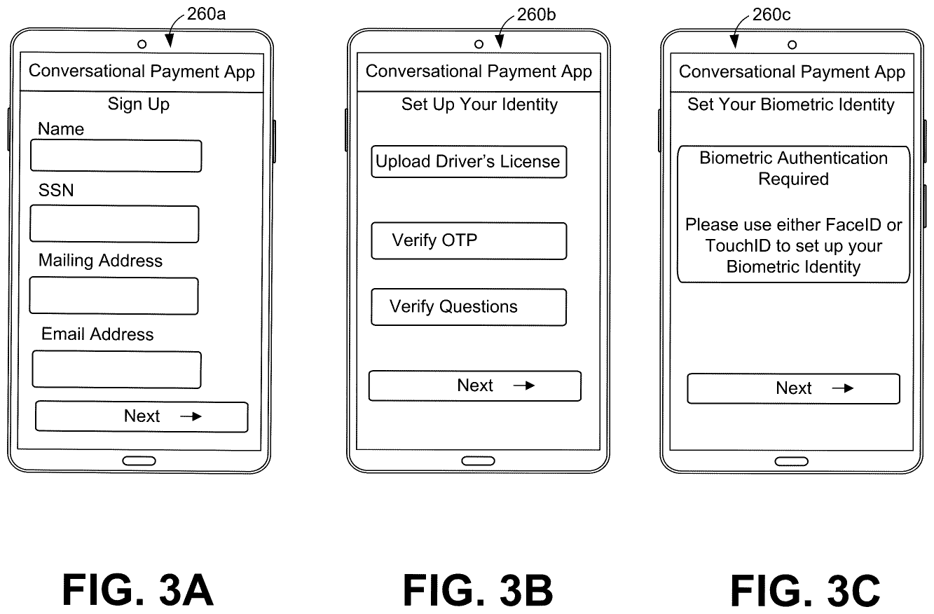

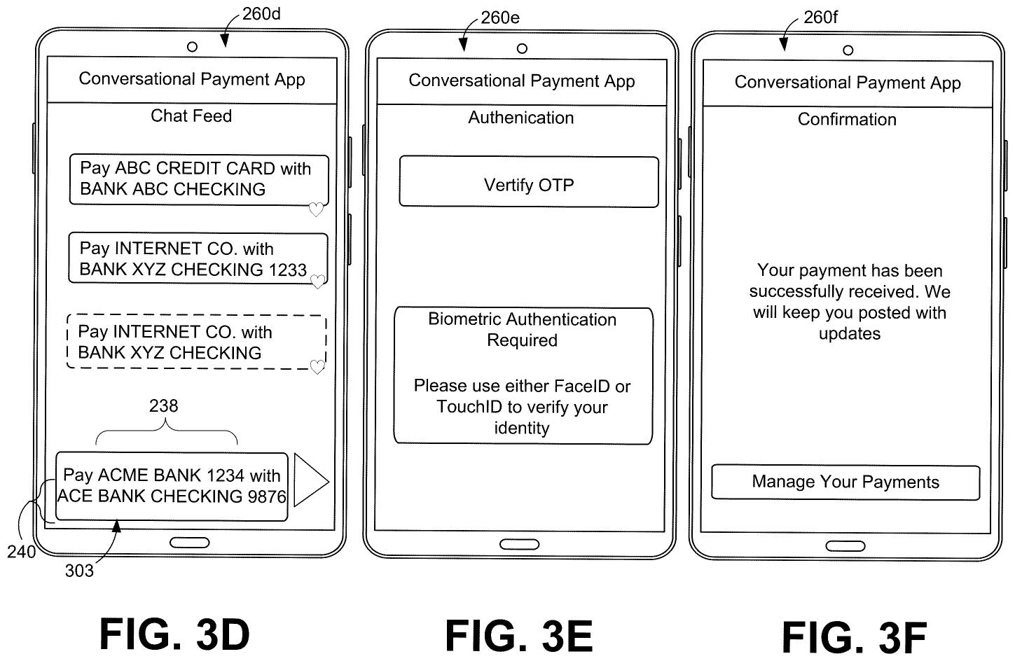

Referring next to FIGS. 3A-3C, shown are user interfaces 260a-260c for configuring or registering a user to use the client application 257 for making payment requests in a text message format. In some examples, the user interfaces 260a-260c can represent user interface transitions, such as user interface 260a transitions to user interface 260b and user interface 260b transitions to user interface 260c.

In FIG. 3A, the user interface 260a is displayed by the client device 212 and includes sign-up user interface components for input of user identity data 246, such as name, social security number, an email address, mailing address, and other suitable user identity data 246. Other user identity data 246 can be requested.

Next, user interface 260b includes input user interface components for the entry of additional user identity data 246, such as driver license information (e.g., driver's license number, an image of driver's license, etc.), passport information, and other suitable information. The user interface 260b also includes user interface components for verifying a one-time password (OTP). The user interface 260b further comprises user interface components for configuring/verifying identity questions.

Next, use interface 260c can be used to configure biometric verification for a user. User interface 260c includes user interface components for capturing biometric data in order to authorize payment requests. In some examples, the biometric verification can rely on the biometric scans used by the mobile operating system (e.g., Apple's Face ID or Touch ID). In some examples, the user interface 260c can be used to capture a biometric scan that is unique to the client application 257. For instance, a unique biometric scan of a fingerprint, a facial scan, or other suitable biometric options. In other examples, the biometric scan can represent a vocal utterance for voice authentication.

Referring next to FIGS. 3D-3F, shown are use interfaces 260d-260f for executing a payment request in the client application 257. The user interfaces 260d-260f can represent interface transitions, such as user interface 260d transitions to user interface 260e and user interface 260e transitions to user interface 260f.

In FIG. 3D, user interface 260d can include includes a record of payment requests and an entry of a new payment request 303. The new payment request 303 can include a first entity identifier 238 (e.g., “ACME BANK 1234”) and a second entity identifier 240 (e.g., “ACE BANKING CHECKING 9876”). In these instances, the first entity identifier 238 and the second entity identifier 240 can have a partial account identifier (e.g., “1234”, “9876”). The partial account identifier can be used to identify a particular billing client account among a list of billing client accounts 239 and/or a particular funding client account among a list of funding client accounts 241. For example, the list of billing clients account 239 can represent multiple credit card accounts of a user at a credit card service provider and the particular account identifier enables for the selection of the intended billing client account for the payment request. Likewise, the partial account identifier can be used for the selection process with a list of the funding client accounts 241. After the new payment request 303 is submitted, the client application 257 can proceed to user interface 260e.

Next, in FIG. 3E, user interface 260e can verify a one-time password (OTP) and can perform a biometric scan using the biometric sensor 256. These security mechanisms can be performed in order to prevent unauthorized users from initiating a new payment request 303. In some instances, these mechanisms can be omitted or initiated upon executing the client application 257. After the biometric verification is complete, the client application 257 can proceed to user interface 260.

Moving to FIG. 3F, user interface 260f can display a confirmation that the new payment request 303 has been received. In some instances, the selection of the “Manage Your Payment” button can cause the client application 257 to proceed to user interface 260d in which the new payment request 303 is displayed in the chat feed as a pending payment request or a completed payment request.

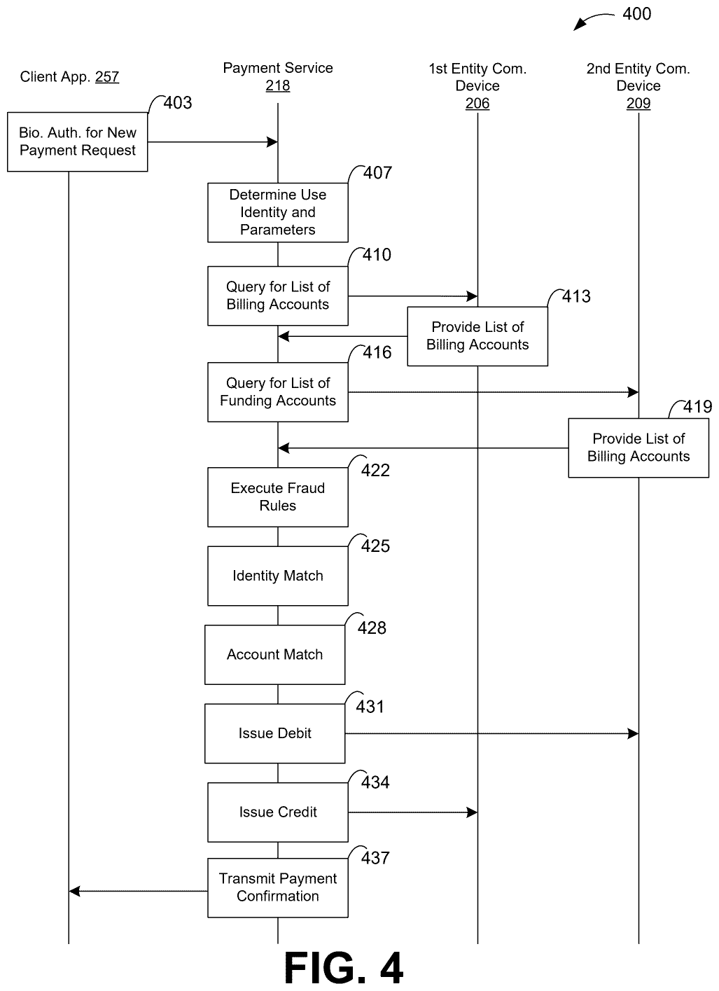

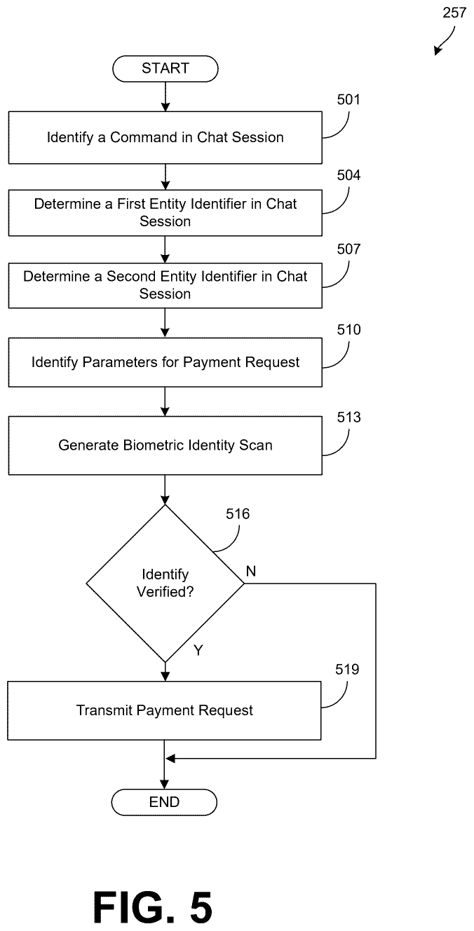

Turning now to FIG. 4, shown is a sequence diagram for the operations of the networked environment 200. The sequence diagram of FIG. 4 provides merely an example of the many different types of functional arrangements that can be employed to implement the operations of the networked environment 200. As an alternative, the flowchart of FIG. 5 can be viewed as depicting an example of elements of a method implemented within the networked environment 200.

To begin, the client device 212 can submit a payment request. The payment request can be in the form of a text message during a chat session. The payment request can include a “Pay” command, a first entity identifier 238, a second entity identifier 240, a user identifier (e.g., user identity data 246), and other suitable data.

In block 403, the client application 257 can execute a biometric authentication for the payment request. The client application 257 can use the biometric sensor 256 to capture a biometric scan (e.g., facial scan, fingerprint scan, vocal utterance) of the user. The client application 257 can compare the biometric scan to data stored as identification verification data 339. Upon successful biometric authentication, the client application 257 can transmit the payment request to the payment service 218.

In block 407, the payment service 218 can determine user identity data 246 (e.g., user identifier) and parameters associated with the payment request. For example, the user identity data 246 can include an email address or a phone number associated with the user of the payment request.

In block 410, the payment service 218 can query the first entity computing device 206 for a list of billing client accounts 239 based at least in part the first entity identifier 238 and the user identity data 246 (e.g., user identifier such as email address, phone number, device identifier, unique user number, etc.). The first entity identifier 238 can be used to identify the first entity computing device 206. The query can include transmitting the user identity data 246 (e.g., an email address or a phone number) to retrieve the list of billing client accounts 239 associated with the user identity data 246. In some examples, the first entity computing device 206 can represent a system of a billing service provider, which have been onboarded or registered with the computing environment 203. The payment data 227 can include network routing information (e.g., IP addresses, application programming interface call (API) calls) for routing queries to the first entity computing device 206.

In block 413, the first entity computing device 206 can transmit the list of billing client accounts 239 to the payment service 218. In some examples, the list of billing client accounts 239 can be transmitted in response to an API call received from the payment service 218.

In block 416, the payment service 218 can query the second entity computing device 209 for a list of funding client accounts 241 based at least in part the second entity identifier 240 and the user identity data 246. The second entity identifier 240 can be used to identify the second entity computing device 209. The query can include transmitting the user identity data 246 to retrieve the list of funding client accounts 241 associated with the user identity data 246. In some examples, the second entity computing device 209 can represent a system of a funding service provider, which have been onboarded or registered with the computing environment 203. The payment data 227 can include network routing information for routing queries to the second entity computing device 209.

In block 419, the second entity computing device 209 can transmit the list of funding client accounts 241 to the payment service 218. In some examples, the list of billing client accounts 239 can be transmitted in response to an API call received from the payment service 218.

In block 422, the payment service 218 can execute one or more fraud rules 236 in order to prevent a fraudulent transaction. For example, a fraud rule can include determining whether the IP address associated with the client device 212 is not associated with a list of compromised devices. In other cases, a fraud rule can include verifying the email address or the phone number of the user identity data 246 is not associated with a list of compromised devices.

In block 425, the payment service 218 can execute an identity match that ensures the user identity data 246 matches in both a particular billing client account 239 and a particular funding client account 241 (e.g., based at least in part on matching data 233). For example, the identity match can involve a matching criteria of a set of three data elements (e.g., name, email address, mailing address) of user identity data 246 at both the particular billing client account 239 and the particular funding client account 241. If the set of three data elements match, then the identity match was a success and the payment request can proceed.

In some examples, the match criteria can be determined by one or more parameters of the payment request. For instance, if the payment amount of the payment request is beyond an amount threshold, then the match criteria can be set to an additional set of user identity data where the additional set of user identity data can represent a greater quantity of user identity data elements than the set of user identity data. For instance, continuing with the previous example, instead of matching three data elements, the matching criteria can be five data elements that are needed to match if the amount threshold is met. The matching criteria can be determined based at least on other conditions, such as the first entity identifier, the second entity identifier, a quantity of previous payment requests made in within a time period, and other suitable conditions.

In block 428, the payment service 218 can perform an account match for the particular billing client account and/or the particular funding client account 241 based at least in part an account match criteria (e.g., account characteristics from the matching data 233). The account match criteria can include an account type match, a partial account identifier match, a funds availability match, and other suitable. For instance, the second entity identifier in the payment request can include an account type. For instance, “BANK ABC CHECKING” indicates that the account type is a checking account. In another example, “AMCE CREDIT CARD 1234” indicates the partial account identifier is “1234” which represent the last four numbers of the actual account number. If the account match is successful, then the payment service 218 can proceed to the block 431.

In block 431, the payment service 218 can issue a debit for an amount of the payment request at the second entity computing device 209 based at least in part on the particular funding client account 241. As such, the amount of the payment request can be withdrawn from the particular funding client account 241. In some embodiments, the debited amount of the payment request is put in a banking account associated with the computing environment 203. In this instance, the banking account can operate similar to an escrow account.

In block 434, the payment service 218 can issue a credit for the amount of the payment request at the first entity computing device 206 based at least in part on the particular billing client account 239. As such, the amount of the payment request can be deposited to the particular billing client account 239. In some embodiments, the issued credit is executed by pulling money from the banking account (e.g., the escrow account that has the debited funds from the funding client account 241) associated with the computing environment 203.

In block 437, the payment service 218 can transmit a payment confirmation to the client application 257. In some examples, the payment request can be updated in a chat feed (FIG. 1) from a pending payment request to a completed payment request.

Referring next to FIG. 5, shown is a flowchart that provides one example of the operation of a portion of the client application 257. The flowchart of FIG. 5 provides merely an example of the many different types of functional arrangements that can be employed to implement the operation of the depicted portion of the client application 257. As an alternative, the flowchart of FIG. 5 can be viewed as depicting an example of elements of a method implemented within the networked environment 200.

Beginning with block 501, the client application 257 can identify a command in a chat session. The client application 257 can identify the command for initiating a payment request. The command can be associated with a chat template for sending payment requests. The chat template 254 for initiating payment requests can include a set of rules for identifying identifiers, parameters, and other suitable data for a payment request. For instance, the entry of “Pay” in the input component 112 (FIG. 1) can be recognized a command for initiating a chat template 254 of the payment request.

In block 504, the client application 257 can determine a first entity identifier 238 in a chat session based at least in part on a first character input or a first series of character input and the chat template 254. After the chat template 254 is identified for the “Pay” command, the client application 257 can proceed to identify a first entity identifier 238 for the text entered into the input component 112. For example, if an entry of “Pay ACME CREDIT CARD with ACE BANKING CHECKING” was made in the input component 112, the client applicant 257 can identify ACME CREDIT CARD as the first entity identifier 238, in which the first entity identifier 238 can be used to identify a billing client account 239. In this example, the “Pay” command is associated a chat template 254 that has a particular sentence or statement structure for having the first entity identifier 238 after the “Pay” command.

In block 507, the client application 257 can determine a second entity identifier 240 for the command based at least in part on a second character input or a second series of character input and the chat template 254. The client application 257 can proceed to identify a second entity identifier 240 for the text entered into the input component 112 as well. Continuing with the previous example, if an entry of “Pay ACME CREDIT CARD with ACE BANKING CHECKING” was made in the input component 112, the client applicant 257 can identify ACE BANKING CHECKING as the second entity identifier 240, in which the second entity identifier 240 can be used to identify a funding client account 241. In this example, the “Pay” command is associated a chat template 254 that has a particular sentence or statement structure for having the second entity identifier 240 located after the “Pay” command and the first entity identifier 238. The command name and the locations of the identifier can vary.

In some embodiments, the client application 257 can have an autocomplete feature that can assist with identifying the first entity identifier 238 and/or the second entity identifier 240. For example, after recognizing an input of one or more characters (e.g., a first capital letter “A”), the client applicant 257 can perform a query in the client data store 263 (or the data store 221) for funding sources 248 and/or billing sources 251 that match the one or more entered characters. As previously mentioned, the funding sources 248 and/the billing sources 251 can represent financial institutions and billing service providers that are associated with the computing environment 203.

In block 510, the client application 257 can identify parameters or conditions associated with the chat session and/or payment request. While the characters are being entered into the input component 112 or after the completion of the payment request, the client application 257 can identify parameters and/or conditions for the payment request. Some non-limiting examples of parameters and conditions include a scheduled time for executing the payment request, a storing instruction for the payment request as a favorite, a repeating instruction for the payment request, and other suitable parameters/conditions.

In block 513, the client application 257 can generate biometric identity scan for the payment request. In some examples, the biometric identity scan can be performed after or before the entry of the payment request. The client application 257 can use the biometric sensor 256 to capture a biometric identity scan. The biometric identity scan can be of a facial scan, a fingerprint scan, a vocal utterance, and other suitable biometric identities scans.

In block 516, the client application 257 can determine whether the identity of the user is verified based at least in part on one or more comparisons to identity verification data 237. For example, the client application 257 can compare the biometric identity scan to a stored biometric identity scan in the identity verification data 237. In some instances, the stored biometric identity scan can be a unique biometric identity scan associated with the client application 257, which may differ from a stored biometric identity used for a mobile operating system. In other instances, the biometric identity scan stored in association with the mobile device operating system can be referenced for the biometric identity verification.

In some examples, the client application 257 can generate and transmit a one-time password to an email address, a phone number or other suitable contact information of the user. The client application 257 can request entry of the OTP and verify the OTP is correct by comparing the entered OTP with the generated OTP.

In block 519, the client application 257 can transmit the payment request to the payment service 218. The payment request can include the first entity identifier 238, the second entity identifier 240, parameters and/or conditions, user identity data 246 (e.g., an email address, a phone number, name), and other suitable conditions.

In some instances, the first entity identifier 238 and/or the second entity identifier 240 can include a partial account identifier. However, it should be appreciated that an entire billing client account 239 and/or an entire funding client account 241 are not needed. By not providing the full account number, the client application 257 provides a quicker and more secure solution for concealing payment information of a user, particularly from unauthorized user that may intercept text messages generated during a chat session on the client device 212.

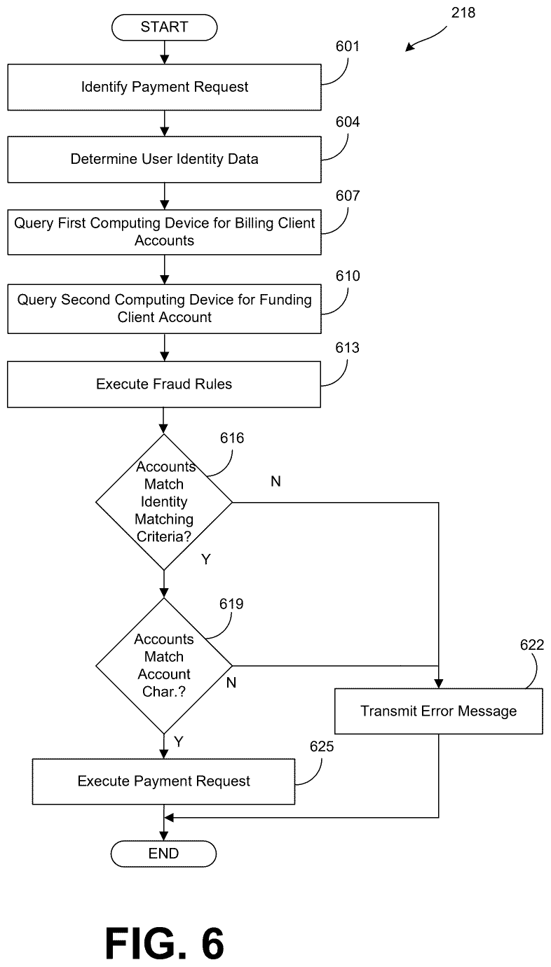

Referring next to FIG. 6, shown is a flowchart that provides one example of the operation of a portion of the payment service 218. The flowchart of FIG. 6 provides merely an example of the many different types of functional arrangements that can be employed to implement the operation of the depicted portion of the payment service 218. As an alternative, the flowchart of FIG. 6 can be viewed as depicting an example of elements of a method implemented within the networked environment 200.

Beginning with block 601, the payment service 218 can identify a payment request from the client application 257. In some instances, the client application 257 can provide to the payment service 218 an indication that the identification verification (e.g., via a biometric authentication) has been successful. In some examples, the client application 257 can transmit the biometric identity scan to the payment service 218 for verification. As such, the payment service 218 can compare the biometric identity scan to a stored biometric identity scan in the data store 221.

In some examples, the payment service 218 can identify a payment request that has been scheduled. For example, the payment service 218 can at periodic intervals look for payment requests stored in the data store 221 which have a scheduled execution time within a particular time window. As such, the payment service 218 may have received the payment request earlier, but does not start processing the payment request until a scheduled time.

In block 604, the payment service 218 can determine user identity data 246 from the payment request. In some examples, the user identity data 246 identified from the payment request can include a phone number, an email address or other user identity data 246. In some instances, the payment service 218 can identify conditions and/or parameters associated with the payment request. The conditions and parameters can include a payment amount, a scheduled payment time, store the payment request as favorite, store the payment request as a repeat payment request, and other suitable data.

In block 607, the payment service 218 can query the first entity computing device 206 for a list of billing client accounts 239 based at least in part on the user identity data 246 and the first entity identifier 238. For example, the payment service 218 can transmit a request for a list of billing client accounts 239 associated with an email address or a phone number associated with a user to the first entity computing device 206. In response to receiving the request, the first entity computing device 206 can transmit to the payment service 218 the list of billing client accounts 239 associated with the email address or the phone number.

In block 610, the payment service 218 can query the second entity computing device 209 for a list of funding client accounts 241 based at least in part on the user identity data 246 and the second entity identifier 240. For example, the payment service 218 can transmit a request for a list of funding client accounts 241 associated with an email address or a phone number associated with a user to the second entity computing device 209. In response to receiving the request, the second entity computing device 209 can transmit to the payment service 218 the list of funding client accounts 241 associated with the email address or the phone number.

In block 613, the payment service 218 can execute one or more fraud rules 236 in association with the payment request, the user identity data 246, the device data 245, and/or other suitable data. For example, a fraud rule can include determining whether the IP address associated with the client device 212 is not associated with a list of compromised devices. In other cases, a fraud rule can include verifying the email address or the phone number of the user identity data 246 is not associated with the list of compromised devices.

In block 616, the payment service 218 can identify client accounts (e.g., billing accounts and the funding accounts) that match one or more identity matching criteria based at least in part on the first list of billing accounts and the second list of funding accounts. The identity matching criteria can be used to determine a billing client account 239 and the funding client account 241 that both satisfy the identity matching criteria (e.g., retrieved from the user identity data 246 and/or matching data 233). For example, the identity matching criteria can include matching a set of three data elements (e.g., name, email address, mailing address) of user identity data 246 at both the particular billing client account 239 and the particular funding client account 241. If the set of three data elements match, then the identity match was a success and the payment service 218 can proceed to block 619. If the set of three data elements do not match, then the identity match was not a success and the payment service 218 can proceed to block 622.

In some examples, the identity match criteria can be determined by one or more parameters of the payment request and/or matching data 233. For instance, if the payment amount of the payment request is beyond an amount threshold, then the match criteria can be set to an additional set of user identity data where the additional set of user identity data can represent a greater quantity of user identity data elements than the set of user identity data. For instance, continuing with the previous example, instead of matching three data elements, the matching criteria can be five data elements are needed to match if the amount threshold is met. The identity matching criteria can be determined based at least on other conditions, such as the first entity identifier 238, the second entity identifier 240, a quantity of previous payment requests made in within a time period, and other suitable conditions.

In block 619, the payment service 218 can determine whether the identified client accounts match an account characteristic based at least in part on the payment request and/or matching data 233. In some examples, the account characteristics are determined from the matching data 233. Some non-limiting examples of account characteristics can include an account type, sufficient available funds for the payment request, partial account number matches account number, and other suitable characteristics.

In block 622, the payment service 218 can transmit an error message to the client device 212 for display. For example, the user interface 260 can be updated to include the error message in the chat feed. In some instances, the user interface 260 can be updated to include an icon that indicates an error (e.g., red symbol).

In block 625, the payment service 218 can execute the payment request based at least in part on the particular billing client account 239 and the funding client account 241 satisfying one or more matching criteria. In some examples, the payment service 218 can issue a debit for the amount of the payment request at the second entity computing device 209 based at least in part on the particular funding client account 241. As such, the amount of the payment request can be withdrawn from the particular funding client account 241.

In some examples, the debited amount of the payment request is put in a banking account associated with the computing environment 203. In this instance, the banking account can operate similar to an escrow account. The payment service 218 can issue credit for the amount of the payment request at the first entity computing device 206 based at least in part on the particular billing client account 239. As such, the amount of the payment request can be deposited to the particular billing client account 239. In some embodiments, the issued credit is executed by pulling money from the banking account (e.g., the escrow account that has the debited funds from the funding client account 241) associated with the computing environment 203.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random-access portion of the memory and run by the processor, source code that can be expressed in proper format such as object code that is capable of being loaded into a random-access portion of the memory and executed by the processor, or source code that can be interpreted by another executable program to generate instructions in a random-access portion of the memory to be executed by the processor. An executable program can be stored in any portion or component of the memory, including random-access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random-access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random-access memory (SRAM), dynamic random-access memory (DRAM), or magnetic random-access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagram of FIG. 4 and the flow charts FIGS. 5 and 6 show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagram of FIG. 4 and the flow charts FIGS. 5 and 6 a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagram of FIG. 4 and the flow charts FIGS. 5 and 6 can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random-access memory (RAM) including static random-access memory (SRAM) and dynamic random-access memory (DRAM), or magnetic random-access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
identify a payment request derived from a text message, the text message being generated by a client device;
determine a user identifier, a first entity identifier, and a second entity identifier associated with the payment request;
query a first entity computing device for a first list of billing accounts based at least in part on the user identifier and the first entity identifier;
query a second entity computing device for a second list of funding accounts based at least in part on the user identifier and the second entity identifier;
identify a billing account and a funding account that matches a set of identity matching criteria based at least in part on the first list of billing accounts and the second list of funding accounts; and
execute the payment request based at least in part on the identification of the billing account and the funding account.

2. The system of claim 1, wherein identifying the funding account further comprises causing the computing device to at least:
verifying the funding account matches an account type indicated in the payment request.

3. The system of claim 1, wherein identifying the funding account further comprises causing the computing device to at least:
verifying the funding account matches a partial account identifier indicated in the payment request.

4. The system of claim 1, wherein identifying the funding account further comprises causing the computing device to at least:
verifying the funding account has sufficient funds for the payment request.

5. The system of claim 1, wherein the user identifier comprises an email address or a phone number associated with a user.

6. The system of claim 1, wherein the identifying the billing account and the funding account that further comprises causing the computing device to at least:
determine a payment amount for the payment request exceeds an amount threshold; and
determine the billing account and the funding account matches an additional set of identity matching criteria based at least in part on the payment amount exceeding the amount threshold, wherein the additional set of identity matching criteria represents a greater quantity of data elements that match than the set of identity matching criteria.

7. The system of claim 1, wherein the set of identity matching criteria comprises at least three of a name, a phone number, an email address, a mailing address, or a social security number.

8. A method, comprising:
identifying, by at least one computing device, a payment request derived from a text message, the text message being generated by a client device;
determining, by the at least one computing device, a user identifier, a first entity identifier, and a second entity identifier associated with the payment request;
querying, by the at least one computing device, a first entity computing device for a first list of billing accounts based at least in part on the user identifier and the first entity identifier;
querying, by the at least one computing device, a second entity computing device for a second list of funding accounts based at least in part on the user identifier and the second entity identifier;
identifying, by the at least one computing device, a billing account and a funding account that matches a set of identity matching criteria based at least in part on the first list of billing accounts and the second list of funding accounts; and
executing, by the at least one computing device, the payment request based at least in part on the identification of the billing account and the funding account.

9. The method of claim 8, wherein identifying the funding account further comprises:
verifying the funding account matches an account type indicated in the payment request.

10. The method of claim 8, wherein identifying the funding account further comprises:
verifying the funding account matches a partial account identifier indicated in the payment request.

11. The method of claim 8, wherein identifying the funding account further comprises:
verifying the funding account has sufficient funds for the payment request.

12. The method of claim 8, wherein the user identifier comprises an email address or a phone number associated with a user.

13. The method of claim 8, wherein identifying the billing account and the funding account that further comprises causing the computing device to at least:
determining a payment amount for the payment request exceeds an amount threshold; and
determining the billing account and the funding account matches an additional set of identity matching criteria based at least in part on the payment amount exceeding the amount threshold, wherein the additional set of identity matching criteria represents a great quantity of data element that match than the set of identity matching criteria.

14. The method of claim 8, wherein the set of identity matching criteria comprises at least three of a name, a phone number, an email address, a mailing address, or a social security number.

15. A system, comprising:
a computing device comprising a processor and a memory; and
machine-readable instructions stored in the memory that, when executed by the processor, cause the computing device to at least:
identify a command in a chat session, the command being associated with a chat template;
determine a first entity identifier associated with the command based at least in part on a first character input and the chat template;
determine a second entity identifier associated with the command based at least in part on a second character input and the chat template;
generate a biometric identify scan for verifying a biometric identify of a user; and
transmit a payment request to a remote computing device based at least in part on a verification of the biometric identify, the payment request comprising the first entity identifier and the second entity identifier.

16. The system of claim 15, wherein the biometric identify is verified based at least in part on a comparison between a stored biometric identifier and the biometric identify scan.

17. The system of claim 15, wherein the machine-readable instructions stored in the memory that, when executed by the processor, cause the computing device to at least:
display a user interface that includes a user interface component associated with the payment request;
identify a payment condition for the payment request based at least in part on a user manipulation associated with the user interface component.

18. The system of claim 15, wherein the payment condition is a scheduled time for executing the payment request.

19. The system of claim 15, wherein the payment condition is an instruction storing the payment request as a favorite command or repeating an execution of the payment request.

20. The system of claim 15, wherein the machine-readable instructions stored in the memory that, when executed by the processor, cause the computing device to at least:
display a chat feed in a user interface that includes the payment request.
